(19) United States
(12) Patent Application Publication
(10) Pub. No.: US 2024/0149387 A1
(43) Pub. Date: May 9, 2024

(54) Hand-Held Electric Polishing of Sanding Power Tool

(71) Applicant: Andrea Valentini, Milano (IT)

(72) Inventor: Andrea Valentini, Milano (IT)

(21) Appl. No.: 18/501,200

(22) Filed: Nov. 3, 2023

(30) Foreign Application Priority Data
Nov. 8, 2022 (EP) 22206141.8

(51) Int. Cl. B24B 23/03; B25F 5/02

(52) U.S. Cl. CPC B24B 23/03; B25F 5/029

(57) ABSTRACT

A hand-held electric power tool comprising an elongated tool housing, that supports an electric motor, and a moveable backing plate protruding externally from the tool housing. The electric motor actuates the backing plate, and the backing plate performs a rotational, random-orbital, orbital or gear-driven working movement in its plane of extension. A bottom surface of the backing plate detachably holds a polishing or sanding member. The tool housing has a rear part formed to be gripped by a hand of a user of the power tool thereby holding the power tool during its intended use and a tubular front part from which the backing plate protrudes, the front part having a smaller diameter than the rear part and being attached to the rear part. At least part of the electric motor may be accommodated in the tubular front part of the tool housing.

### CROSS-REFERENCE TO RELATED APPLICATIONS

The present application which claims priority to and all the benefits of European Patent Application No. 22206141.8, filed on Nov. 8, 2022, the entire contents of which are hereby expressly incorporated herein by reference.

### BACKGROUND OF THE INVENTION

### 1. Field of the Invention

The present invention is generally directed toward electric power tools, and more specifically to hand-held electric polishing or sanding power tools.

### 2. Description of the Related Art

Polishing or sanding power tools of the above identified kind are well known in the prior art. For instance, RUPES S.p.A. from Vermezzo (MI), Italy, was the first company to develop and launch back in 2014 the RUPES® Big Foot® iBrid® Nano, a mini polisher of the above-identified kind. The elongated tool housing is relatively compact especially with regard to its diameter and particularly light in weight. The tubular front part of the housing has an even smaller diameter than the rear part of the tool housing permitting a user of the power tool to reach tight and cramped spaces and to work (i.e. polish or sand) small surfaces, in particular in these tight and cramped spaces.

The known polishing or sanding power tools must have an electric motor of a certain strength in order to be able to operate the backing plate or the polishing or sanding member, respectively, with enough torque. Generally, the amount of torque which can be provided by an electric motor depends (apart from the magnetic force) on the motor's external diameter, limiting a virtual lever between a rotational axis of a rotor of the motor and a point of application of the magnetic force between a stator of the motor and the rotor. Therefore, for reasons of space, the electric motor is always located in the rear part of the tool housing of the known power tools, because the rear part of the tool housing has a larger diameter than the tubular front part. Besides, the rear part usually being made of plastic material can be easily provided with venting openings allowing a cooling air stream to dissipate heat from the electric motor and other electronic components of the power tool to the environment.

Due to its small inner diameter, the tubular front part of the tool housing cannot receive any of the components of the power tool except for an extension shaft mounted therein by bearings and connecting a motor shaft of the electric motor with a bevel gear arrangement and/or a tool shaft to which the backing plate is attached and which drives the backing plate in order to realize its working movement. The extension shaft merely serves for transferring a rotational speed and a torque from the motor shaft in the rear part of the tool housing to the bevel gear arrangement and/or the tool shaft in the tubular front part of the housing.

The diameter of the front part of the tool housing cannot simply be enhanced in order to accommodate a conventional electric motor therein because in that case a user of the power tool could no longer reach tight and cramped spaces and work (i.e. polish or sand) small surfaces in these tight and cramped spaces. Therefore, the present invention refers to rather compact so-called mini or nano polishers and sanders.

The known power tools have the disadvantage that the electric motor occupies a large amount of space in the rear part of the tool housing leaving only little space for other components of the power tool, like an electronic control unit, switches, potentiometers, receptacles for batteries etc. Furthermore, the fact that almost all components of the power tool are located in the rear part of the tool housing leads to an overweight in the rear part and to an uneven distribution of the weight.

Therefore, it is an object of the present invention to provide for a more equilibrated power tool having more space in the rear part of the tool housing for other components, like additional batteries. In particular, it is an object to use the space available inside the entire tool housing more efficiently.

### SUMMARY OF THE INVENTION

The present invention is directed to a hand-held electric polishing or sanding power tool that includes an elongated tool housing, in which an electric motor is accommodated, and a moveable backing or support plate protruding externally from the tool housing. The electric motor is adapted to actuate the backing plate, the backing plate, thereby performing a rotational, random-orbital, orbital or gear-driven working movement in its plane of extension. A bottom surface of the backing plate is adapted to detachably hold a polishing or sanding member. The tool housing has a rear part adapted and formed to be gripped by a hand of a user of the power tool, thereby holding the power tool during its intended use and a tubular front part from which the backing plate protrudes externally, the front part having a smaller diameter than the rear part and being attached to the rear part. Additional features of the present invention will be further summarized below.

More specifically, the invention suggests the use of a particularly slim electric motor which fits into the tubular front part of the tool housing. The invention requires the use of an electric motor in the power tool which has a smaller external diameter than the conventional electric motors usually used in known mini or nano polishers or sanders. Conventional electric motors have an external diameter of approximately 3.0-4.0 cm, in particular approximately 3.5-3.7 cm, so they can be accommodated only in the rear part of the tool housing having an external diameter of approximately 4.0-5.5 cm, in particular approximately 4.4-4.8 cm. The tubular front part of the tool housing has an external diameter of approximately 2.0-3.5 cm, in particular of approximately 2.5-3.2 cm. This means that the electric motor used in the power tool according to the invention must have an external diameter of less than the external diameter of the front part of the tool housing, in particular of approximately 1.8-3.4 cm, particularly preferred of 2.0-3.2 cm.

To this end, it is suggested that the electric motor has an outer diameter of less than 3.4 cm, preferably of less than 3.0 cm, particularly preferred of less than 2.6 cm.

A theoretically (due to the reduced diameter of the electric motor) reduced torque, which can be provided by the motor of the power tool according to the invention, can be compensated by the use of new highly efficient high-performance permanent magnets in the motor. Such magnets may be made of or may comprise a rare-earth metal, for example neodym. The use of such magnets in the electric motor can compensate for the smaller diameter of the motor with a greater magnetic force. A higher efficiency and smaller dimensions of the electric motor can also be obtained by the use of a brushless electric motor.

Further, in order to reduce the diameter of the tubular front part of the tool housing, the outer wall of the tubular front part could also be used as the stator of a brushless electric motor of the inrunner type (external stator and internal rotor, in contrast to an electric motor of the outrunner type). In that case, the electric motor would constitute an integral part of the tubular front part of the tool housing, i.e. would be integrated therein.

The present invention has the advantage that it provides for a more equilibrated power tool having more space in the rear part of the tool housing for other components, like additional batteries. In particular, the space available inside the entire tool housing can be used more efficiently.

Furthermore, cooling of the electric motor during its operation can be achieved rather easily if the external housing of the electric motor, which is usually made of metal, is in thermal contact (directly or indirectly using heat conducting elements) with the front part of the tool housing, which is preferably also made of metal. Heat can thus be dissipated directly from the electric motor to the environment via the front part of the housing.

The invention has the above indicated advantages even if only part of the electric motor is accommodated in the tubular front part of the tool housing. The more of the electric motor is accommodated in the front part of the tool housing, the more space is created in the rear part of the tool housing for other components of the power tool. However, according to one embodiment of the invention, it is suggested that the entire electric motor is accommodated in the tubular front part of the tool housing, thereby creating a maximum amount of space in the rear part of the tool housing for other components of the power tool.

In one embodiment, the rear part of the tool housing is made of a plastic material and/or the tubular front part of the tool housing is made of metal or a composite material comprising metal. The rear part of the tool housing can have a basically cylindrical form. However, indentations and protrusions may be provided on the outside of the rear part of the tool housing to give the rear part an ergonomic shape that facilitates gripping and holding of the power tool with one hand of the user.

The front part of the tool housing has an essentially cylindrical form. In particular, it is suggested that most part of the tubular front part of the tool housing has the form of a hollow cylinder. At a rear end of the front part of the tool housing, at the transition to the rear part, the front part may have a continuously or stepwise increasing external diameter. A cylindrical section may also be attached to a front end of the front part of the tool housing. At the transition from the front end to the cylindrical section, the external diameter of the front part of the tool housing may also increase continuously or stepwise.

A longitudinal extension of the cylindrical section preferably runs at an angle to the longitudinal extension of the tubular front part of the tool housing. The angle is preferably 80°-100°, particularly preferably 85°-95°, most preferably 90°. While a motor shaft extends along the longitudinal extension of the front part of the tool housing, a tool shaft extends along the longitudinal extension of the front cylindrical section. An angular gear arrangement, for example a bevel gear arrangement, is arranged between the shafts, inside the front part of the tool housing. A gearwheel of the angular gear arrangement, which may include a bevel gear wheel, may be attached or forms an integral part of the motor shaft. Another gearwheel of the angular gear arrangement, for example another bevel gear wheel, in mesh with the first gearwheel may be attached or forms an integral part of the tool shaft.

Thus, it is suggested that a first rotational axis of a motor shaft of the electric motor and a second rotational axis of a tool shaft of the power tool, to which the backing plate is attached and which drives the backing plate in order to realize its working movement, extend in an angle in respect to each other. The angle is preferably in the range of 45° to 135°, preferably in the range of 80° to 100°, particularly preferable 90°.

The backing plate may be directly or indirectly attached to the end of the tool shaft opposite to the angular gear arrangement. In the case where the backing plate is directly attached to the tool shaft, the backing plate performs a rotary working movement in the plane of extension of the backing plate.

In the case of an indirect attachment, an eccentric element may be disposed between the backing plate and the tool shaft. In one embodiment, the eccentric element is attached to the tool shaft in a torque proof manner, i.e. a torque may be transmitted from the tool shaft to the eccentric element. A rotary shaft of the backing plate, preferably provided on a top surface of the backing plate and extending along a rotational axis of the backing plate, is attached to the eccentric element in a freely rotatable manner. The rotational axes of the tool shaft and of the backing plate are spaced apart and extend parallel to each other. This results in a free rotation of the backing plate in respect to the eccentric element superimposing the forced rotational movement of the eccentric element about the rotational axis of the tool shaft, resulting in an overall so-called random-orbital working movement.

In case the free rotation of the backing plate in respect to the tool housing is blocked by one or more elastic or magnetic elements acting between the backing plate and the tool housing, the backing plate performs a so-called orbital (or eccentric) working movement. The elastic element may comprise a circumferential collar made of an elastic material, e.g. rubber or an elastomer, which is attached to the top surface of the backing plate and to the tool housing. Alternatively, one or more magnetic elements comprising magnets and/or ferromagnetic elements are provided in the tool housing and in corresponding positions in the top surface of the backing plate. The corresponding magnetic elements attract each other magnetically, thereby limiting the free rotation of the backing plate in respect to the tool housing.

Finally, it is also possible that the backing plate is indirectly attached to the tool shaft using a gear arrangement, for example an epicyclic or planetary gear arrangement. The tool shaft is attached or forms an integral part of a first gear wheel of the gear arrangement. A rotary shaft of the backing plate, preferably provided on a top surface of the backing plate and extending along a rotational axis of the backing plate, is attached to another gear wheel of the gear arrangement. The rotational axes of the tool shaft and of the backing plate are spaced apart and extend parallel to each other. During rotation of the tool shaft the backing plate performs a so-called gear-driven working movement. With that type of working movement, every complete rotation of the backing plate around its rotational axis corresponds to a fixed number of orbits of the backing plate. The fixed number of orbits depends on the design of the gear arrangement and can vary between approximately 2 and 20, in particular between 6 and 16, particularly preferred between 8 and 14.

The eccentric element or the gear arrangement provided functionally between the tool shaft and the rotary shaft of the backing plate may be covered by a protective cap or shroud, which may be attached to a distal or bottom end of the cylindrical section of the front part of the tool housing. In one embodiment, the protective cap or shroud is made of plastic and/or rubber material. It may be detachably attached to the cylindrical section, e.g. by one or more magnets, snap-in connections or a threaded connection. In the latter case, the distal or bottom end of the cylindrical section may be provided with an external thread, and the top end of the cap or shroud may be provided with a respective internal thread adapted to be screwed onto the distal or bottom end of the cylindrical section.

The eccentric element is preferably detachably attached to the tool shaft allowing replacement of a first eccentric element by another eccentric element, e.g. having another orbit than the first eccentric element. In this manner, the orbit of the random-orbital working movement of the backing plate may be switched between, e.g. 3 mm and 12 mm or other values. Furthermore, the eccentric element could be replaced by a simple shaft-like extension element or the backing plate could be attached directly to the distal end of the tool shaft, resulting in a rotary working movement of the backing plate. In this manner, the working movement of the backing plate could be switched between a random-orbital and a rotary working movement.

The eccentric element could be attached to the tool shaft using a snap-in connection or a threaded connection or in any other way. The snap-in connection holds the eccentric element in respect to the tool shaft in an axial direction, i.e. parallel to the rotational axis of the tool shaft. In a circumferential direction, i.e. in a plane extending perpendicularly in respect to the axial direction and the rotational axis of the tool shaft, a form-fit connection may be provided preventing rotation of the eccentric element in respect to the tool shaft about the rotational axis of the tool shaft.

According to another embodiment of the invention, it is suggested that a reduction gear arrangement may be located functionally between the motor shaft of the electric motor and the tool shaft of the power tool to which the backing plate is attached and which drives the backing plate in order to realize its working movement. A reduction gear reduces the speed between input and output, i.e. between the motor shaft and the tool shaft, by a given ratio i>1. In return, the torque is increased accordingly in the same ratio. According to DIN, the transmission ratio i is defined as the quotient of the speed of the input and the speed of the output, i.e. the quotient of the speed of the motor shaft and the speed of the tool shaft. If the ratio i>1, the speed is reduced but the transmitted torque is increased. According to this embodiment a very high-speed motor is used, which preferably achieves a maximum speed of at least 10,000 rpm, preferably at least 15,000 rpm, particularly preferable at least 20,000 rpm. The rather high speed of the motor shaft is reduced by the reduction gear arrangement to a maximum speed of at least 3,000 rpm, preferably at least 4,000 rpm, particularly preferable at least 5,000 rpm. At the same time, the torque acting on the backing plate is significantly increased. A reduction in torque caused by the slimmer design and the reduced diameter of the electric motor can be compensated for by the reduction gear.

The reduction gear arrangement may be separate from or may form an integral part of the bevel gear arrangement, which is located functionally between the motor shaft of the electric motor and the tool shaft of the power tool to which the backing plate is attached and which drives the backing plate in order to realize its working movement. Thus, the bevel gear arrangement may have a transmission ratio i of i=1 (requiring a separate reduction gear arrangement if a speed reduction and torque enhancement is desired) or of i>1 (with the reduction gear arrangement forming an integral part of the bevel gear arrangement).

It is further suggested that the rear part of the tool housing may be provided with an actuator for turning the electric motor on or off and/or with an adjustment mechanism for adjusting a speed of the electric motor, wherein the actuator and/or the adjustment mechanism are arranged and designed to be operated from outside the tool housing by a user's hand or finger. According to this embodiment, the power tool is not only held by a user's hand at the rear part of the tool housing, but can also be operated by the user with his hand from the rear part of the tool housing. Operation of the power tool may comprise turning on and/or off the electric motor thereby setting the backing plate into rotation or stopping its rotation and/or adjusting the speed of the electric motor and, consequently, of the backing plate. Additionally, operation of the power tool may comprise the control of other functions of the power tool, e.g. a light for illuminating a working surface on which the polishing or sanding member attached to the backing plate works during intended use of the power tool or a turbo mode, in which the speed of the electric motor can be temporarily further increased for a short period of time.

The actuator and/or the adjustment mechanism may be arranged in the rear part of the tool housing and designed to be operated from outside the tool housing by the user's hand or finger when holding the power tool with his hand. To this end, the actuator and/or the adjustment mechanism are provided in the rear part of the tool housing, for example in a manner protruding from the outside surface of the rear part of the housing. The actuator may include sliding elements, toggle elements, push buttons and/or rotating elements, such as knurled wheels or the like.

It is further suggested that the actuator may include an actuating switch or an actuating lever. The actuating lever may have a longitudinal extension running parallel to the longitudinal extension of the tool housing. The actuating lever may be attached to the tool housing pivotable about a pivot axis extending perpendicular to the longitudinal extension of the lever. The actuating lever may be attached to a top surface of the rear part of the tool housing permitting actuation via a user's handball when holding the power tool with his hand. Alternatively, the actuating lever may be attached to a bottom surface of the rear part of the tool housing permitting actuation via a user's fingers when holding the power tool with his hand. The actuating switch may be arranged in the rear part of the tool housing such that it can be actuated by a user's thumb when holding the power tool with his hand.

According to another embodiment of the invention, it is suggested that the adjustment mechanism may include a potentiometer, having, for example a rotating contact forming an adjustable voltage divider, or two push buttons, one for increasing and another one for decreasing the speed of the electric motor. In one embodiment, the potentiometer is in connection with a rotating actuating element, such as a knurled wheel or the like. The actuating element is rotatable about a rotation axis which extends radially in respect to the longitudinal extension of the tool housing. Rotation of the rotating actuating element adjusts the voltage divider and changes the output voltage (corresponding to the input voltage of the electric motor) and, thus, the speed of the electric motor.

### BRIEF DESCRIPTION OF THE DRAWINGS

Further features and advantages of the present invention are described in more detail in the following description referring to the accompanying drawings. It is emphasized that each of the features shown in the figures may be of particular importance to the invention on its own, even if not explicitly shown in the drawings and not explicitly mentioned hereinafter. Furthermore, any combination of features shown in the figures may be of particular importance to the invention, even if that combination is not explicitly shown in the drawings and not explicitly mentioned hereinafter. The invention will be described with reference to the following figures wherein:

FIG. 1 is a hand-held electric polishing or sanding power tool according to one embodiment of the invention in a perspective view;

FIG. 2 is an exploded view of a hand-held electric polishing or sanding power tool;

FIG. 3 is an exploded view of the power tool of FIG. 1;

FIG. 4 is a bottom or distal end of a front part of a tool housing of the power tool of FIG. 1 with a protruding tool shaft;

FIG. 5 is the bottom or distal end of FIG. 4 with an eccentric element attached to the protruding tool shaft;

FIG. 6 is the bottom or distal end of FIG. 4 with a shaft-like extension element attached to the protruding tool shaft;

FIG. 7 is a partial view of a hand-held electric polishing or sanding power tool according to another embodiment of the invention with alternative actuators and adjustment mechanisms; and

FIG. 8 is another embodiment of a hand-held electric polishing or sanding power tool according to the invention in a side view.

### DETAILED DESCRIPTION OF THE INVENTION

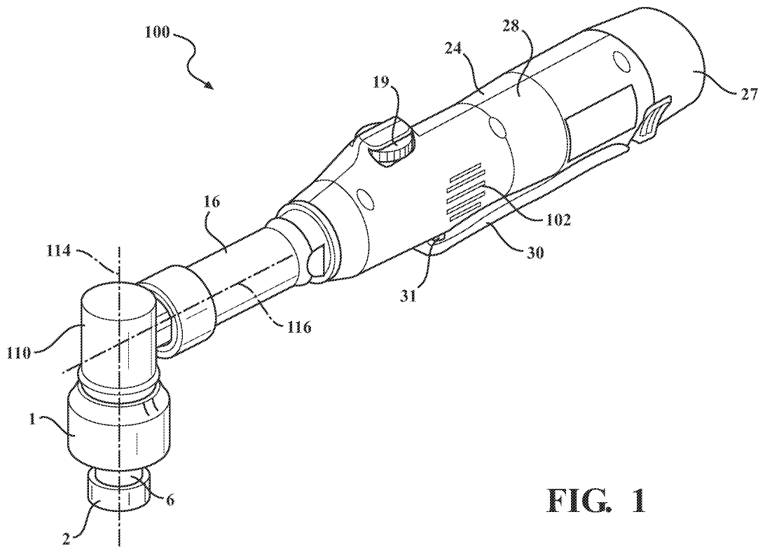

A hand-held electric polishing or sanding power tool 100 according to one embodiment of the present invention is shown in FIG. 1. The power tool 100 comprises an elongated tool housing, in which an electric motor 23 is accommodated. The tool housing has a rear part preferably made of plastic and adapted and formed to be gripped by a hand of a user of the power tool 100 thereby holding the power tool 100 during its intended use. In the shown embodiment, the rear part of the tool housing is made up of two halves, a right half 24 and a left half 28, which are screwed together using screws 29 or any other suitable fastener. The rear part 24, 28 of the tool housing may be manufactured by injection moulding.

The tool housing further comprises a tubular front part 16 preferably made of metal, for example aluminium, or a material compound comprising any other suitable metal. The front part 16 of the tool housing may be made by milling or by die cast. The front part 16 may be attached to the rear part 24, 28 of the tool housing, using, for example, a threaded connection, screws or the like. It would also be conceivable for the front part 16 of the tool housing to be inserted between the two halves 24, 28 of the rear part of the tool housing and to be held in place by them when the two halves 24, 28 are closed and fastened together. It is further conceivable that the front part 16 of the tool housing may be attached to the rear part 24, 28 in at least two different rotational positions about a longitudinal axis of the tool housing, the longitudinal axis extending parallel to a longitudinal extension 116 of the tubular front part 16 of the tool housing. The front part 16 has a smaller external diameter than the rear part 24, 26 of the tool housing.

Furthermore, the power tool 100 has a moveable backing plate 2 protruding externally from the tool housing, in particular from the front part 16 of the tool housing. The electric motor 23 is adapted to actuate the backing plate 2. Depending on the type of connection of the backing plate 2 to a tool shaft 7 of the power tool 100, the backing plate 2 may perform a rotational, a random-orbital, an orbital (or eccentric) or a gear-driven working movement in its plane of extension. The backing plate 2 is preferably made of a rigid plastic material and/or metal. The backing plate 2 may comprise a resilient bottom layer made of an elastic plastic material, rubber or the like, and fixedly attached to a bottom surface of the rigid plastic and/or metal.

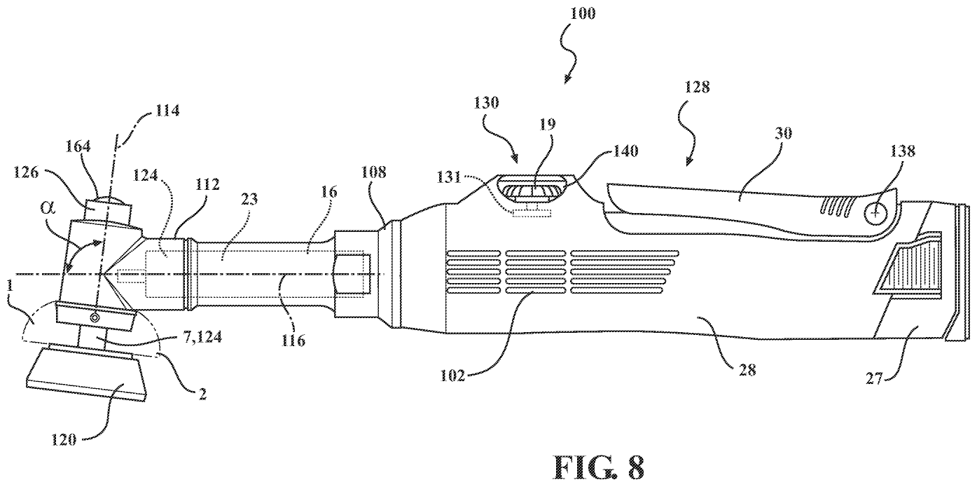

A bottom surface of the backing plate 2 is adapted to detachably hold a polishing or sanding member 120 (see FIG. 8). The bottom surface may be formed by the rigid plastic and/or metal or it may be formed by the resilient bottom layer, if present. To this end, the bottom surface of the backing plate 2 may be provided with an adhesive layer or with a layer of a hook-and-loop fastener (Velcro®). The polishing or sanding member 120 may have a corresponding even top surface for attachment to the adhesive layer or a corresponding layer of the hook-and-loop fastener (Velcro®) for attachment to the layer of a hook-and-loop fastener of the bottom surface of the backing plate 2. Of course, other types of releasable attachment of a polishing or sanding member 120 to the bottom surface of the backing plate 2 are conceivable, too, e.g. by adhesion or a detachable adhesive connection.

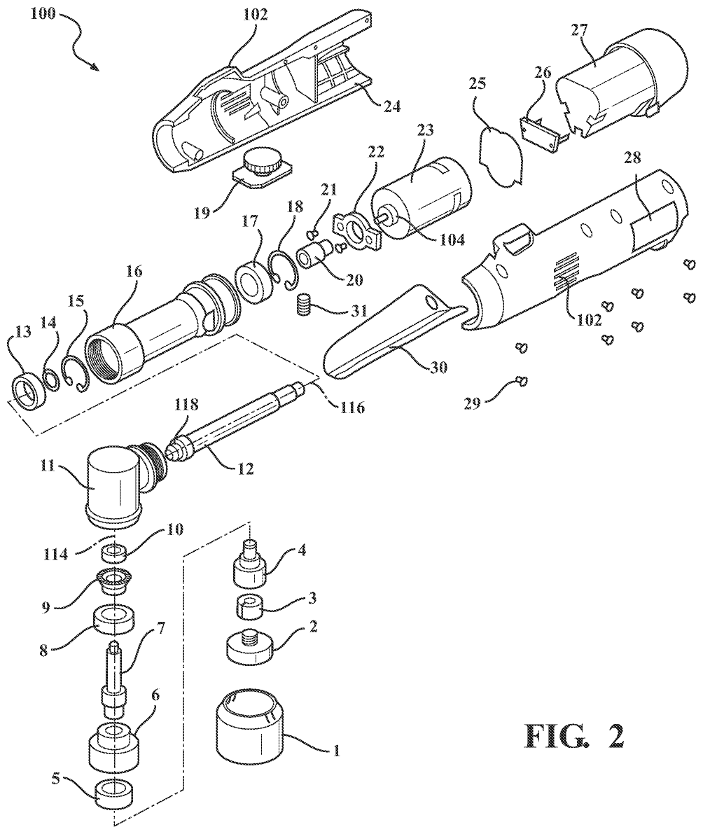

FIG. 2 shows another embodiment of a polishing or sanding power tool 100, where like numerals are used to designate like components with respect to the other embodiments disclosed herein. The elongated tool housing 16, 24, 28 is relatively compact especially with regard to its external diameter and particularly light in weight. The tubular front part 16 of the housing has an even smaller diameter than the rear part 24, 28 of the tool housing permitting a user of the power tool 100 to reach tight and cramped spaces and to work (i.e. polish or sand) small surfaces, in particular in these tight and cramped spaces.

In power tools 100 of the type shown in FIG. 2, for reasons of space, the electric motor 23 is always located in the rear part 24, 28 of the tool housing, because the rear part 24, 28 has a larger diameter than the tubular front part 16. The reason for this is that electric motors 23 providing a sufficiently large maximum torque for use in the power tools 100 have a respectively large external diameter which will fit in the rear part 24, 28 of the tool housing only. Besides, the rear part 24, 28 usually being made of plastic material can be easily provided with venting openings 102 allowing a cooling air stream to dissipate heat from the electric motor 23 and other electronic components of the power tool 100 to the environment.

Conventional electric motors 23 have an external diameter of approximately 3.0-4.0 cm, in particular approximately 3.5-3.7 cm, so they can be accommodated only in the rear part 24, 28 of the tool housing having an external diameter of approximately 4.0-5.5 cm, in particular approximately 4.4-4.8 cm.

Due to its small inner diameter, the tubular front part 16 of the tool housing cannot receive any of the components of the power tool 100 except for an extension shaft 12 mounted therein using bearings 13, 17 and connecting a motor shaft 104 of the electric motor 23 with a bevel gear arrangement 9, 118 and/or a tool shaft 7 to which the backing plate 2 is attached and which drives the backing plate 2 in order to realize its working movement. The extension shaft 12 merely serves for transferring a rotational speed and a torque from the motor shaft 104 in the rear part 24, 28 of the tool housing to the bevel gear arrangement 9, 118 and/or the tool shaft 7 in the tubular front part 16 of the tool housing.

The diameter of the front part 16 of the tool housing cannot simply be enhanced in order to accommodate a conventional electric motor 23 therein because in that case a user of the power tool 100 could no longer reach tight and cramped spaces and work (i.e. polish or sand) small surfaces in these tight and cramped spaces. Therefore, the present invention refers to rather compact so-called mini or nano polishers and sanders.

Power tools 100, like the one shown in FIG. 2, have the disadvantage that the electric motor 23 occupies a large amount of space in the rear part 24, 28 of the tool housing leaving only little space for other components of the power tool 100, like an electronic control unit, a printed circuit board, switches, potentiometers 131, receptacles for a battery 27 etc. Furthermore, the fact that almost all components of the power tool 100 are located in the rear part 24, 28 of the tool housing leads to an overweight in the rear part 24, 28 and to an uneven distribution of the weight.

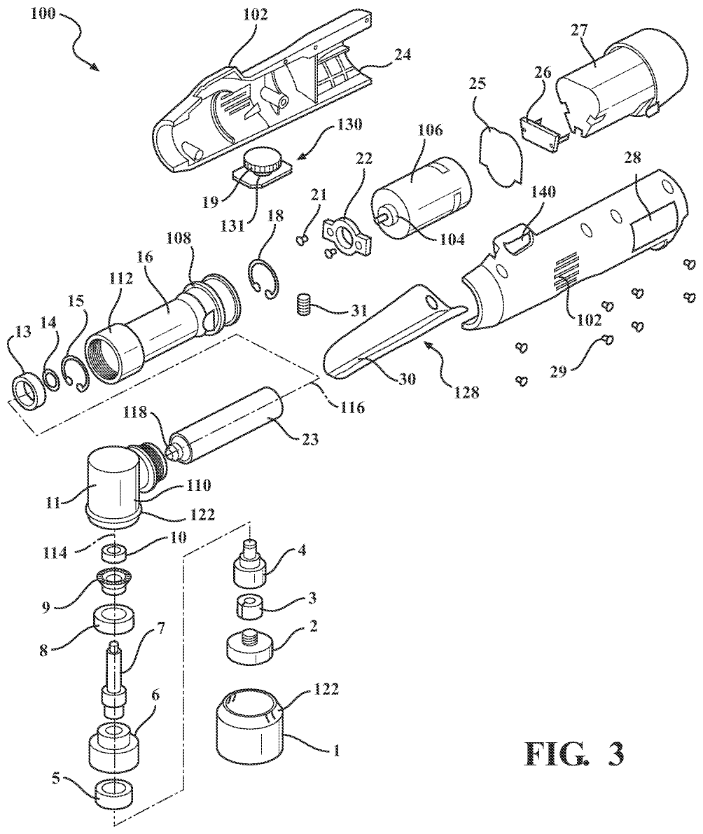

As can be seen in FIG. 3, in order to overcome these deficiencies of certain prior art mini or nano polishing or sanding power tools, at least part of the electric motor 23 is accommodated in the tubular front part 16 of the tool housing.

To this end, the power tool of the present invention employs a particularly slim electric motor 23 which fits into the tubular front part 16 of the tool housing. The invention requires the use of an electric motor 23 in the power tool 100 which has a smaller external diameter than the conventional electric motors usually used in known mini or nano polishers or sanders. The tubular front part 16 of the tool housing has an external diameter of approximately 2.0-3.5 cm, in particular of approximately 2.5-3.2 cm. This means that the electric motor 23 used in the power tool 100 according to the invention must have an external diameter of less than the external diameter of the front part 16 of the tool housing, in particular of approximately 1.8-3.4 cm, particularly preferred of 2.0-3.2 cm. To this end, it is suggested that the electric motor 23 has an outer diameter of less than 3.4 cm, preferably of less than 3.0 cm, particularly preferred of less than 2.6 cm.

A theoretically (due to the reduced diameter of the electric motor 23) reduced torque, which can be provided by the motor 23 of the power tool 100 according to the invention, can be compensated by the use of new highly efficient high-performance permanent magnets in the motor 23. Such magnets may be made of or may comprise a rare-earth metal, for example neodym. The use of such magnets in the electric motor 23 can compensate for the smaller diameter of the motor 23 with a greater magnetic force. A higher efficiency and smaller dimensions of the electric motor 23 can also be achieved by the use of a brushless motor.

The present invention has the advantage that it provides for a more equilibrated power tool 100 having more space 106 in the rear part of the tool housing for other components, like additional batteries. In particular, the space 106 available inside the entire tool housing 16, 24, 28 can be used more efficiently.

Furthermore, cooling of the electric motor 23 during its operation can be achieved rather easily if the external housing of the electric motor 23, which is usually made of metal, is in thermal contact (directly or indirectly using heat conducting elements) with the front part 16 of the tool housing, which is preferably also made of metal. Heat can thus be dissipated directly from the electric motor 23 to the environment via the metal front part 16 of the housing.

The invention has the above indicated advantages even if only part of the electric motor 23 is accommodated in the tubular front part 16 of the tool housing. The more of the electric motor 23 is accommodated in the front part 16 of the tool housing, the more (the larger a) space 106 is created in the rear part 24, 28 of the tool housing for other components of the power tool 100. However, according to one embodiment of the invention, it is suggested that the entire electric motor 23 is accommodated in the tubular front part 16 of the tool housing, thereby creating a maximum amount of space 106 in the rear part 24, 28 of the tool housing for other components of the power tool 100.

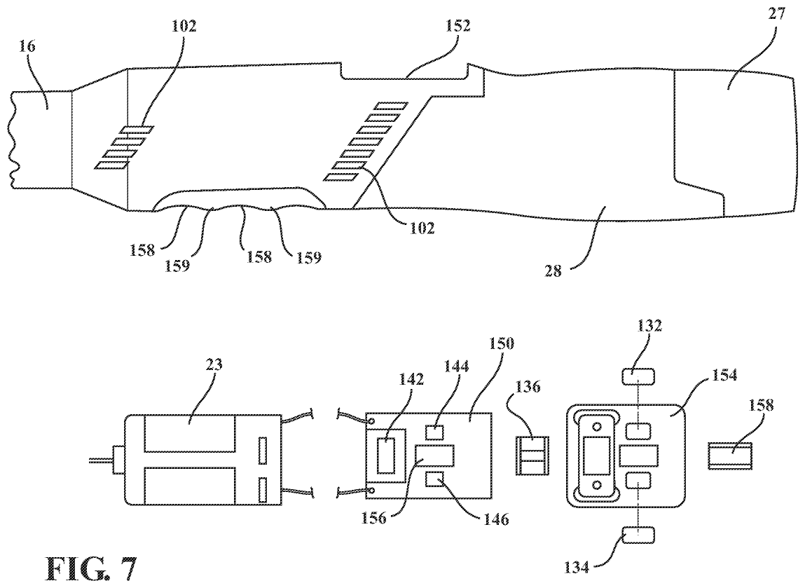

In one embodiment, the rear part 24, 28 of the tool housing is made of a plastic material and/or the tubular front part 16 of the tool housing is made of metal or a composite material comprising metal. The rear part 24, 28 of the tool housing can have a basically cylindrical form. However, indentations 158 and protrusions 159 (see FIG. 7) may be provided on the outside of the rear part 24, 28 of the tool housing to give the rear part 24, 28 an ergonomic shape that facilitates gripping and holding of the power tool 100 with one hand of the user.

The front part 16 of the tool housing may have an essentially cylindrical form. In one embodiment, it is suggested that most part of the tubular front part 16 of the tool housing has the form of a hollow cylinder. As can be seen in FIGS. 3 and 8, at a rear end 108 of the front part 16 of the tool housing, at the transition to the rear part 24, 28, the front part 16 may have a continuously or stepwise increasing external diameter. A cylindrical section 110 may also be attached to a front end 112 of the front part 16 of the tool housing. At the transition from the front end 112 to the cylindrical section 110, the external diameter of the front part 16 of the tool housing may also increase continuously or stepwise.

A longitudinal extension 114 of the cylindrical section 110 preferably runs at an angle α in respect to the longitudinal extension 116 of the tubular front part 16 of the tool housing. Theoretically, the angle α may have any desired value in the range of 45° to 135°. The angle α is preferably 80°-100°, particularly preferably 85°-95°, most preferably 90°. In the embodiment of FIGS. 1 and 3, the angle α is exactly 90°. In the embodiment of FIG. 8, the angle α is approximately 97°.

While a motor shaft 104 extends along the longitudinal extension 116 of the front part 16 of the tool housing, the tool shaft 7 extends along the longitudinal extension 114 of the front cylindrical section 110. To this end, bearings 8, 10 may be provided inside the cylindrical section 110 which receive and guide the tool shaft 7 in a freely rotatable manner. An angular gear arrangement 9, 118, in particular a bevel gear arrangement, is arranged between the shafts 104, 7, inside the front part 16 of the tool housing. No or only a very small extension shaft, similar to extension shaft 12 of FIG. 2, is provided between the motor shaft 104 and the bevel gear arrangement 9, 118. A gearwheel 118 of the angular gear arrangement, in particular a bevel gear wheel, forms an integral part of the motor shaft 104. Of course, the gearwheel 118 may also be designed separately from the motor shaft 104 and attached thereto. Furthermore, the gearwheel 118 could also be attached to a short extension shaft provided between the motor shaft 104 and the gear arrangement 9, 118. Another gearwheel 9 of the angular gear arrangement, in particular another bevel gear wheel, in mesh with the first gearwheel 118 is attached to the tool shaft 7. Of course, the gearwheel 9 may also form an integral part of the tool shaft 7.

The backing plate 2 may be directly attached to the distal end of the tool shaft 7 opposite to the angular gear arrangement 9, 118 (see FIG. 8). In this case, the backing plate 2 performs a rotary working movement in the plane of extension of the backing plate 2. A rotational axis of the backing plate 2 and a rotational axis of the tool shaft 7 are congruent and correspond to the longitudinal extension 114 of the front cylindrical section 110. A direct attachment of the backing plate 2 to the tool shaft 7 also comprises the case where a shaft-like extension element 160 with one end is attached to the tool shaft 7 and with its opposite end is attached to the backing plate 2 (see FIG. 6). In one embodiment, the extension element 160 is attached to the tool shaft 7 and to the backing plate 2 in a torque proof manner, i.e. a torque may be transmitted from the tool shaft 7 to the backing plate 2.

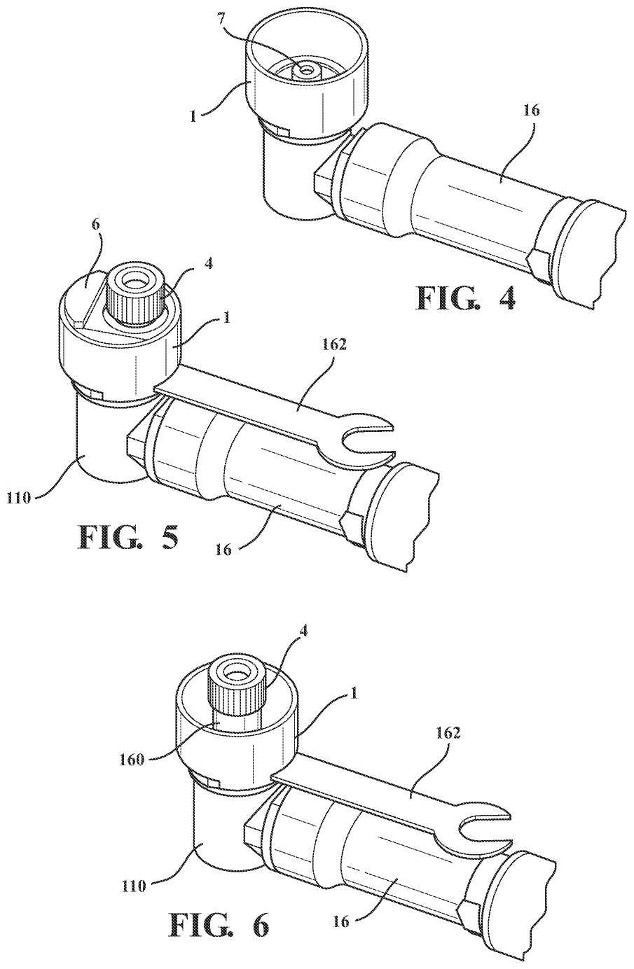

Alternatively, the backing plate 2 is indirectly attached to the distal end of the tool shaft 7 (see FIG. 3). In this case, an eccentric element 6 may be disposed between the backing plate 2 and the tool shaft 7 (see FIG. 5). In one embodiment, the eccentric element 6 is attached to the tool shaft 7 in a torque proof manner, i.e. a torque may be transmitted from the tool shaft 7 to the eccentric element 6. A rotary shaft 4 of the backing plate 2, provided on a top surface of the backing plate 2 and extending along a rotational axis of the backing plate 2, is attached to the eccentric element 6 in a freely rotatable manner. To this end, a bearing 5 is provided in the eccentric element 6, which is adapted to receive and receive in a freely rotatable manner the rotatory shaft 4 of the backing plate 2. The rotational axes of the tool shaft 7 and of the backing plate 2 are spaced apart and extend parallel to each other. This results in a free rotation of the backing plate 2 in respect to the eccentric element 6 superimposing the forced rotational movement of the eccentric element 6 about the rotational axis of the tool shaft 7, resulting in a so-called random-orbital working movement.

In the embodiment of FIG. 3, the rotary shaft 4 of the backing plate 2 is attached thereto using a separate threaded seat 3. Of course, it would also be possible, that the rotary shaft 4 is directly attached to the backing plate 2 or that the rotary shaft 4 forms an integral part of a top surface of the backing plate 2, thereby allowing omission of the threaded seat 3.

In case the free rotation of the backing plate 2 in respect to the tool housing 16, 24, 28 is blocked by one or more elastic or magnetic elements (not shown) acting between the backing plate 2 and the tool housing 16, 24, 28, the backing plate 2 performs a so-called orbital (or eccentric) working movement. The elastic element may comprise a circumferential collar made of an elastic material, e.g. rubber or an elastomer, which is attached to the top surface of the backing plate 2 and to the tool housing 16, 24, 28. Alternatively, one or more magnetic elements comprising magnets and/or ferromagnetic elements are provided in the tool housing 16, 24, 28 and in corresponding positions in the top surface of the backing plate 2. The corresponding magnetic elements attract each other magnetically, thereby limiting the free rotation of the backing plate 2 in respect to the tool housing 16, 24, 28 (e.g. see EP 3 736 084 B1).

Finally, it is also possible that the backing plate 2 is indirectly attached to the tool shaft 7 using a gear arrangement, for example an epicyclic or planetary gear arrangement (not shown). The tool shaft 7 is attached or forms an integral part of a first gear wheel of the gear arrangement. A rotary shaft 4 of the backing plate 2, located on a top surface of the backing plate 2 and extending along a rotational axis of the backing plate 2, is attached to another gear wheel of the gear arrangement. The rotational axes of the tool shaft 7 and of the backing plate 2 are spaced apart and extend parallel to each other. During rotation of the tool shaft 7 the backing plate 2 performs a so-called gear-driven working movement. With that type of working movement, every complete rotation of the backing plate 2 around its rotational axis 114 corresponds to a fixed number of orbits of the backing plate 2. The fixed number of orbits depends on the design of the gear arrangement and can vary between approximately 2 and 20, in particular between 6 and 16, particularly preferred between 8 and 14.

The eccentric element 6 or the gear arrangement provided functionally between the tool shaft 7 and the rotary shaft 4 of the backing plate 2 may be covered by a protective cap or shroud 1, which may be attached to a distal or bottom end of the cylindrical section 110 of the front part 16 of the tool housing. The protective cap or shroud 1 may be made of plastic and/or rubber material. It may be detachably attached to the cylindrical section 110, e.g. using one or more magnets (e.g. see EP 3 854 526 A1), snap-in connections 122 or a threaded connection. In the latter case, the distal or bottom end of the cylindrical section 110 may be provided with an external thread, and the top end of the cap or shroud 1 may be provided with a respective internal thread adapted to be screwed onto the distal or bottom end of the cylindrical section 110. Additionally, the cylindrical section 110 may be completely covered by a damping cap (not shown) made of a resilient material, in order to avoid scratches or damage of the area to be worked, in particular in tight and cramped spaces, by the metal of the cylindrical section 110.

The eccentric element 6 is preferably detachably attached to the tool shaft 7 allowing replacement of a first eccentric element 6 by another eccentric element 6 (see FIG. 3), e.g. having another orbit than the first eccentric element 6. In this manner, the orbit of the random-orbital working movement of the backing plate 2 may be switched between, e.g. 3 mm and 12 mm or other values. Furthermore, the eccentric element 6 could be replaced by a simple shaft-like extension element 160 (see FIG. 6) or the backing plate 2 could be attached directly to the distal end of the tool shaft 7 (see FIG. 8), resulting in a rotary working movement of the backing plate 2. In this manner, the working movement of the backing plate 2 could be switched between a random-orbital and a rotary working movement.

Rotation of the tool shaft 7 should be blocked during detachment and attachment of the eccentric element 6 or the shaft-like extension element 160 or the backing pad 2 from/to the tool shaft 7. This may be achieved using a tool 162, e.g. a wrench, to be inserted through a slit of the cap or shroud 1 in order to engage with the tool shaft 7 and to prevent it from rotating (see FIGS. 5 and 6). Alternatively, the rotation of the tool shaft 7 during detachment and attachment of the eccentric element 6 or the shaft-like extension element 160 or the backing pad 2 from/to the tool shaft 7 may be achieved by a blocking mechanism making part of the power tool 100 and being actuated by pressing a blocking button 164 (see FIG. 8). Of course, the blocking button 164 could also be located at any other position on the front part 16 of the tool housing.

The eccentric element 6 could be attached to the tool shaft 7 using a snap-in connection or a threaded connection or in any other way. The snap-in connection holds the eccentric element 6 in respect to the tool shaft 7 in an axial direction, i.e. parallel to the rotational axis (corresponding to the longitudinal extension 114) of the tool shaft 7. In a circumferential direction, i.e. in a plane extending perpendicularly in respect to the axial direction and the rotational axis of the tool shaft 7, a form-fit connection may be provided preventing rotation of the eccentric element 6 in respect to the tool shaft 7 about the rotational axis of the tool shaft 7.

According to another embodiment of the invention, it is suggested that a reduction gear arrangement 124 is located functionally between the motor shaft 104 of the electric motor 23 and the tool shaft 7 of the power tool 100 to which the backing plate 2 is attached and which drives the backing plate 2 in order to realize its working movement. The reduction gear 124 reduces the speed between input and output, i.e. between the motor shaft 104 and intermediary output shaft 126 or the tool shaft 7, respectively, by a given ratio i>1. In return, the torque is increased accordingly in the same ratio i. According to DIN, the transmission ratio i is defined as the quotient of the speed of the input and the speed of the output, i.e. the quotient of the speed of the motor shaft 104 and the speed of the output shaft 126 or the tool shaft 7, respectively. If the ratio i>1, the speed is reduced but the transmitted torque is increased. According to this embodiment a very high-speed motor 23 is used, which may achieve a maximum speed of at least 10,000 rpm, preferably at least 15,000 rpm, particularly preferable at least 20,000 rpm. The rather high speed of the motor shaft 104 is reduced by the reduction gear arrangement 124 to a maximum speed of at least 3,000 rpm, preferably at least 4,000 rpm, particularly preferable at least 5,000 rpm. At the same time, the torque acting on the backing plate 2 is significantly increased. A reduction in torque caused by the slimmer design and the reduced diameter of the electric motor 23 can be compensated for by the reduction gear arrangement 124.

The reduction gear arrangement 124 may be separate from or may form an integral part of the bevel gear arrangement 9, 118, which is located functionally between the motor shaft 104 of the electric motor 23 and the tool shaft 7 of the power tool 100. In the embodiment of FIG. 8 a reduction gear arrangement 124 separate from the bevel gear arrangement 9, 188 is shown. In this case, the bevel gear arrangement 9, 18 may have a transmission ratio i of i=1. The speed reduction and torque enhancement are effected by the separate reduction gear arrangement 124 having a transmission ratio of I>1.

When a separate reduction gear arrangement 124 is used, the gear wheel 118 of the angular gear arrangement may be attached to or form an integral part of the output shaft 126 of the reduction gear arrangement 124. The motor shaft 104 acts as input shaft of the reduction gear arrangement 124. The separate reduction gear arrangement 124 is may also be housed by the tubular front part 16 of the tool housing, for example between the electric motor 23 and the bevel gear 124.

In the embodiment of FIG. 3 a reduction gear arrangement 124 forming an integral part of the bevel gear arrangement 9, 118 is shown. In this case, the bevel gear arrangement 9, 18 may have a transmission ratio i of i>1 thereby providing for the speed reduction and torque enhancement.

It is further suggested that the rear part 24, 28 of the tool housing is provided with an actuator 128 for turning the electric motor 23 on or off and/or with an adjustment mechanism 130 for adjusting a speed of the electric motor 23. The actuator 128 and/or the adjustment mechanism 130 are arranged and designed to be operated from outside the tool housing 16, 24, 28 by a user's hand or finger. The actuator 128 and/or the adjustment mechanism 130 may include a switch, a potentiometer or the like.

According to this embodiment, the power tool 100 is not only held by a user's hand at the rear part 24, 28 of the tool housing, but can also be operated by the user with his hand or fingers from the rear part 24, 28 of the tool housing. Operation of the power tool 100 may include turning on and/or off the electric motor 23 thereby setting the backing plate 2 into rotation or stopping its rotation and/or adjusting the speed of the electric motor 23 and, consequently, of the backing plate 2. Additionally, operation of the power tool 100 may include the control of other functions of the power tool 100, e.g. a light for illuminating a working surface on which the polishing or sanding member 120 attached to the backing plate 2 works during intended use of the power tool 100 or a turbo mode, in which the speed of the electric motor 23 can be temporarily further increased for a short period of time.

Actuating elements 19, 30 in connection with the actuator 128 and/or the adjustment mechanism 130 are provided in the rear part 24, 28 of the tool housing, for example in a manner protruding from the outside surface of the rear part 24, 28 of the housing. An actuating element in connection with the adjustment mechanism 130 may include a sliding element, a toggle element, a push button 132, 134 and/or a rotating element 19, such as s knurled wheel or the like. An actuating element in connection with the actuator 128 may comprise a sliding element 136, a push button, a rotating element 19, such as a knurled wheel, or an actuating lever 30.

The actuating lever 30 may have a longitudinal extension running parallel to the longitudinal extension of the tool housing 16, 24, 28. The actuating lever 30 is attached to the rear part 24, 28 of the tool housing pivotable about a pivot axis 138 extending perpendicular to the longitudinal extension of the lever 30. In the embodiment of FIG. 8, the actuating lever 30 is attached to a top surface of the rear part 24, 28 of the tool housing permitting actuation by a user's handball when holding the power tool 100 with his hand. In the embodiment of FIG. 3, the actuating lever 30 is attached to a bottom surface of the rear part 24, 28 of the tool housing permitting actuation by a user's fingers when holding the power tool 100 with his hand. An actuating switch is arranged in the rear part 24, 28 of the tool housing such that it may be actuated by the lever 30. A spring 31 may be provided in order to force the lever 30 away from the rear part 24, 28 of the tool housing when not actuated by the user.

The potentiometer 131 of the adjustment mechanism 130 has a rotating contact forming an adjustable voltage divider. The rotating actuating element 19, e.g. a knurled wheel, is rotatable about a rotation axis which extends radially in respect to the longitudinal extension of the tool housing. The rotating element 19 is located in an elevation on the top of the rear part 24, 28 of the tool housing. The elevation has lateral cut-outs 140 permitting access to and actuation of the rotating element 19. The rotating element 19 may be attached to the rotating contact of the potentiometer 131 thereby allowing adjustment of the output voltage of the potentiometer 131 when rotating the rotating element 19. Rotation of the rotating actuating element 19 adjusts the voltage divider and changes the output voltage (corresponding to the input voltage of the electric motor 23) and, thus, the speed of the electric motor 23.

In an alternative embodiment shown in FIG. 7, the actuator 128 for turning the electric motor 23 on or off comprise a toggle switch 142 which is actuated by an actuating element in the form of a sliding element 136. The sliding element 136 and the corresponding toggle switch 142 can be switched between a “ON”-position, indicated by “1” and an “OFF”-position, indicated by “0”. The adjustment mechanism 130 for adjusting the speed of the electric motor 23 comprise two pressure switches 144, 146 which are actuated by adjustment elements comprising two push buttons 132, 134. One of the push buttons 132 is marked with “−” for reducing the speed of the electric motor 23 and the other push button 134 is marked with “+” for increasing the speed of the electric motor 23.

A small display 148 is located between the two push buttons 132, 134. The display 148 displays numbers between “1” and “9” indicative of the currently set speed of the electric motor 23.

The toggle switch 142 and the pressure switches 144, 146 are attached to and electrically contacted by a printed circuit board (PCB) 150. The PCB 150 is in electrical contact with the electric motor 23 (shown only schematically). The PCB 150 is located in the rear part 24, 28 of the tool housing below an opening 152 provided in a top surface of the rear part 24, 28. The sliding element 136 and the push buttons 132, 134 as well as the display 148 are attached to or form part of a cover element 154, which is adapted to be inserted into and close the opening 152. The cover element 154 may be made of a rigid material or of a plastic foil. When the cover element 154 is inserted into and closes the opening 152, the sliding element 136 and the push buttons 132, 134 are in contact with the toggle switch 142 and the pressure switches 144, 146 allowing their actuation and the display 148 is in contact with electrical contacts 156 provided on the PCB 150.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A hand-held electric polishing or sanding power tool comprising an elongated tool housing, in which an electric motor is accommodated, and a moveable backing plate protruding externally from the tool housing,
wherein the electric motor is adapted to actuate the backing plate, the backing plate thereby performing a rotational, random-orbital, orbital or gear-driven working movement in its plane of extension,
wherein a bottom surface of the backing plate is adapted to detachably hold a polishing or sanding member, and
wherein the tool housing has a rear part adapted and formed to be gripped by a hand of a user of the power tool thereby holding the power tool during its intended use and a tubular front part from which the backing plate protrudes, the front part having a smaller diameter than the rear part and being attached to the rear part,
wherein at least part of the electric motor is accommodated in the tubular front part of the tool housing.

2. The power tool as set forth in claim 1, wherein the entire electric motor is accommodated in the tubular front part of the tool housing.

3. The power tool as set forth in claim 1, wherein the rear part of the tool housing is made of a plastic material and/or the tubular front part of the tool housing is made of metal or a composite material comprising metal.

4. The power tool as set forth in claim 1, wherein a portion of the tubular front part of the tool housing has the form of a hollow cylinder.

5. The power tool as set forth in claim 1, wherein a reduction gear arrangement is located functionally between a motor shaft of the electric motor and a tool shaft of the power tool to which the backing plate is attached and which drives the backing plate in order to realize its working movement.

6. The power tool as set forth in claim 1, wherein the rear part of the tool housing is provided with an actuator for turning the electric motor on or off and/or with an adjustment mechanism for adjusting a speed of the electric motor, wherein the actuator and/or the adjustment mechanism are arranged and designed to be operated from outside the tool housing by a user's hand or finger.

7. The power tool as set forth in claim 6, wherein the actuator comprise includes an actuating switch or an actuating lever.

8. The power tool as set forth in claim 6, wherein the adjustment mechanism includes a potentiometer, with a rotating contact forming an adjustable voltage divider, or two push buttons, one for increasing and another one for decreasing the speed of the electric motor.

9. The power tool as set forth in claim 1, wherein a first rotational axis of a motor shaft of the electric motor and a second rotational axis of a tool shaft of the power tool to which the backing plate is attached and which drives the backing plate in order to realize its working movement, extend in an angle (α) in respect to each other, the angle (α) being in the range of 45° to 135°, preferably in the range of 80° to 100°, particularly preferable 90°.

10. The power tool as set forth in claim 9, wherein an angular gear arrangement is located functionally between a motor shaft of the electric motor and a tool shaft of the power tool to which the backing plate is attached and which drives the backing plate in order to realize its working movement.

11. The power tool as set forth in claim 10, wherein the angular gear arrangement has a transmission ratio (i) of larger than one (i>1).

12. The power tool as set forth in claim 1, wherein the electric motor has an outer diameter (d) of less than 3.4 centimetres (d<3.4 cm), preferably of less than 3.0 centimetres (d<3.0 cm), particularly preferred of less than 2.6 centimetres (d<2.6 cm).
